(19) United States
(12) Patent Application Publication
(10) Pub. No.: US 2007/0211895 A1
(43) Pub. Date: Sep. 13, 2007

(54) DATA PROCESSING TECHNIQUE COMPRISING ENCRYPTION LOGIC

(76) Inventors: Reinhard Steffens, Santa Clara, CA (US); Sebastian Kaluza, Munich (DE)

Correspondence Address: O'SHEA, GETZ & KOSAKOWSKI, P.C., 1500 MAIN ST., SUITE 912, SPRINGFIELD, MA, 01115, US

(21) Appl. No.: 11/684,975

(22) Filed: Mar. 12, 2007

(30) Foreign Application Priority Data
Mar. 10, 2006 (DE) 10 2006 011 223.7

(51) Int. Cl. H04L 9/00

(52) U.S. Cl. 380/42

(57) ABSTRACT

A data processing technique includes encryption/decryption of an input dataword using a key to obtain an output dataword. Reversible single-bit operations are applied to the input dataword before the encryption or decryption, and/or application of single-bit operations to the output dataword obtained by the encryption or decryption, wherein the single-bit operations are represented by a completely minimized Boolean operation.

### PRIORITY INFORMATION

This patent application claims priority from German patent application 10 2006 011 223.7 filed Mar. 10, 2006, which is hereby incorporated by reference.

### BACKGROUND INFORMATION

The invention relates to a data processing technique which comprises encryption logic.

The increasing amounts of digital audio and video data transferred over public networks is increasing the need for encryption and decryption of digital data. In addition, to ensure adequate copy protection, audio and video data are often stored in encrypted form on a data media (e.g., CD, DVD). The encryption, and in particular decryption, are typically performed by a specially developed circuit that can be implemented, for example, in an ASIC. However, as a result of technical advances, it is increasingly becoming possible also to implement this encryption and decryption in a commercially available PC in real time—with the result that the risk of misuse of the copyrighted material is also increasing.

A known approach to preventing the encryption or decryption of data on a PC is to make the encryption algorithms more complex so as to increase their processing time required by the CPU of a PC such that the data can no longer be processed in real time. From a practical standpoint, however, it would be desirable to be able to use conventional encryption algorithms in unchanged form.

There is a need for an encryption/decryption technique that is easily implemented on an integrated circuit such as an ASIC, but not executable in real-time on a PC.

### SUMMARY OF THE INVENTION

A data processing technique includes encryption/decryption of an input dataword using a key to obtain an output dataword. Reversible single-bit operations are applied to the input dataword before the encryption or decryption, and/or application of single-bit operations to the output dataword obtained by the encryption or decryption, wherein the single-bit operations are represented by a reduced Boolean operation.

The reduced Boolean operation may be a minimized Boolean operation.

Advantageously, the data processing technique is easily implemented on an integrated circuit such as an ASIC, but is preferably not executable in real-time on a personal computer.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1A illustrates the use of single-bit operations;

FIG. 1B illustrates by way of example the use of single-bit operations as in FIG. 1A—however, comprising the use of an additional keyword;

FIG. 2A illustrates the incorporation of single-bit operations into a Feistel structure by the use of which single-bit operations can be reversed;

FIG. 2B illustrates a receiver-side data processing chain comprising the deceleration incorporated into a Feistel structure, and the decryption logic;

FIG. 2C illustrates the transmitter-side data processing chain comprising encryption logic and deceleration logic incorporated into a Feistel structure;

FIG. 2D illustrates an alternative transmitter-side data processing chain in which encryption logic is implemented in parallel to the single-bit operations;

FIG. 3A illustrates processing comprising transmitter-side encryption and receiver-side decryption, wherein deceleration logic is provided before and after each encryption and decryption procedure;

FIG. 3B illustrates processing comprising transmitter-side encryption and receiver-side decryption, wherein deceleration logic is provided after the encryption and before the decryption; and

FIG. 3C illustrates processing comprising transmitter-side encryption and receiver-side decryption, wherein deceleration logic is provided before the encryption and after the decryption.

### DETAILED DESCRIPTION OF THE INVENTION

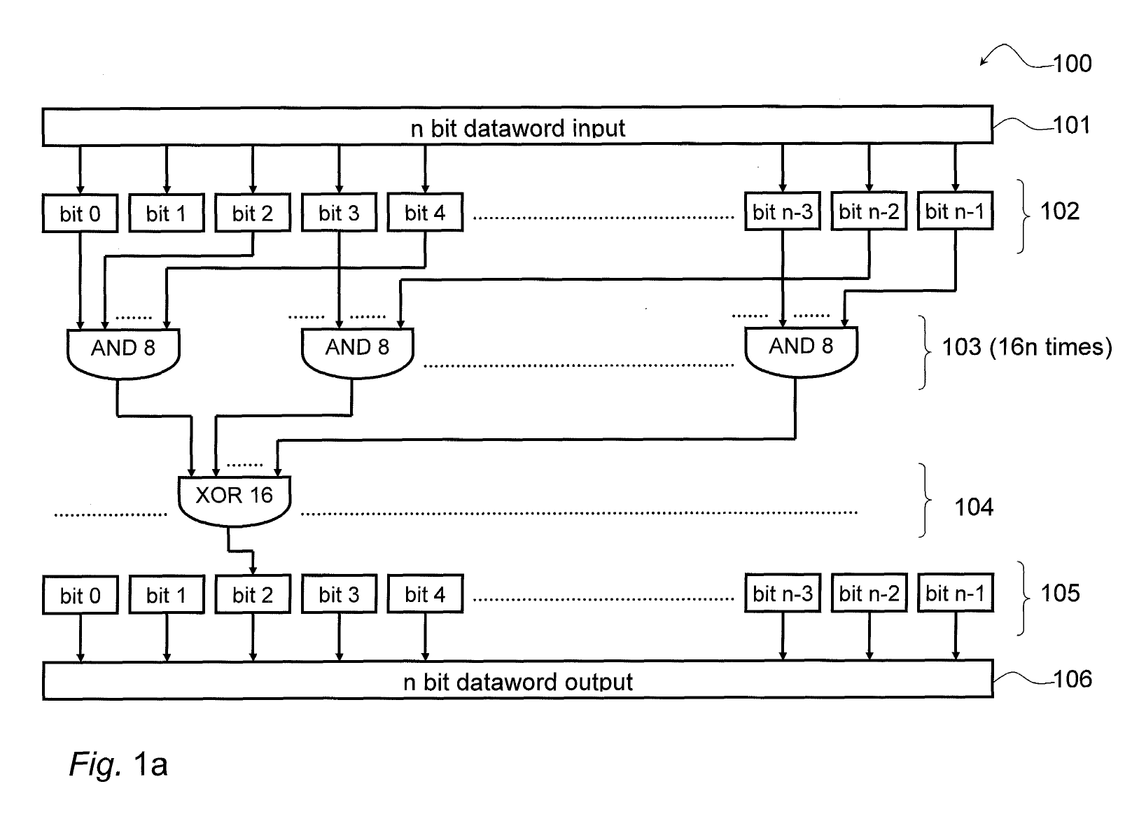

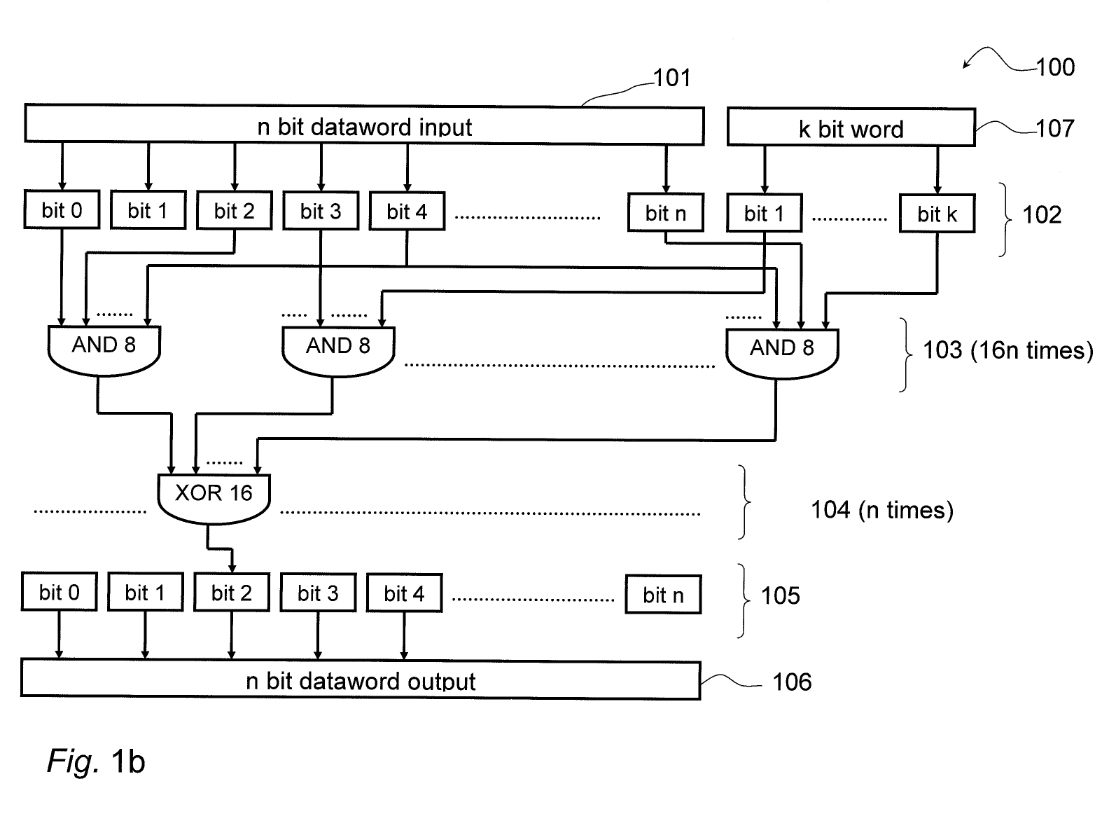

FIG. 1A illustrates a logic circuit 100 which provides single-bit operations to a dataword 101 before and/or after an encryption or decryption. These single-bit operations can preferably be effected on the CPU of a PC very slowly, whereas they can be effected quickly and efficiently on an application-specific integrated circuit. The logic circuit 100 thus serves to effect a “deceleration” of the data processing, this deceleration being especially effective for data processing in the CPU of a PC, with the result that data processing in real time is rendered significantly more difficult.

In the example shown in FIG. 1A, single bits 102 of the dataword 101 are logically linked by AND operators 103 and XOR operators 104. In this example, eight single bits 102 each of the n-bit-wide input dataword 101 are logically combined with an 8-input-AND-operator 103.

A total of 16×n different combinations of the bits 102 are logically combined with the 16×n 8-input-AND-operators 103. Of these logic results, 16 each are then logically combined with a 16-input-XOR operator 104. For this purpose, n such 16-input-XOR operators 104 are required. The results of these n XOR operations represent the single bits 105 of an output dataword 106 that is produced from input dataword 101 after implementation of the single-bit operations.

The above-described processing technique is able in particular—by an approach to be described in more detail below—to be applied to encrypted datawords before decryption, and/or to decrypted datawords after decryption, in a data decryption unit to which encrypted data are fed for decryption. Here an operation inverse to that effected by the deceleration logic must be implemented in an encryption unit that supplies the encrypted dataword.

The single-bit operations can be represented in the form of Boolean operations that map the input dataword 101 of deceleration logic 100 to the output dataword 106. In order to optimally achieve the goal of deceleration, the Boolean function that represents the single-bit operation is preferably minimal. The Boolean function representing the single-bit operations 100 should in other words not be capable of being further minimized by minimization techniques, such as, for example, that of Quine/McCluskey or that of Karnaugh/Veitch—that is, the number of operations required to map the input dataword 101 to the output dataword should not be able to be reduced. This is the same as not allowing the number of logic gates present in the deceleration logic 100 to be reduced further.

It should be noted that any desired combination of logical operations may be applied to generate the input dataword 101. In addition to the AND and XOR operations described above by way of example, NAND and NOR operations (not shown) are in particular suitable for this purpose.

In addition, the Boolean function must not represent any higher-order functions such as, for example, addition, multiplication, et cetera, since standard CPUs are optimized for these and the desired deceleration would then not be achieved.

In addition to the n-bit-wide input dataword 101, the example shown in FIG. 1B also uses a k-bit-wide keyword 107 to map the input dataword 101 to output dataword 106. The bits from the keyword 107 are treated like bits from the input dataword, wherein n bits are generated at the output from the n+k bits fed to the logic 100.

In an approach analogous to the example shown in FIG. 1A, a total of 16×n combinations from a total of (n+k) single bits from both the datawords 100 and 107 are logically linked by 16×n 8-input-AND operators 103. The 16×n logic results are again logically linked with the n 16-input-XOR operators 104 in order finally to obtain the n single bits 105 of the output dataword.

The logic 100 shown in FIGS. 1A and 1B is generally not reversible, that is, the input dataword 101 cannot be recovered from the output dataword 106 which was generated from input dataword 101 by the single-bit operations 103, 104. This procedure is thus not reversible. However, reversibility is a requirement in order to be able to employ the deceleration logic in a decryption unit without loss of data.

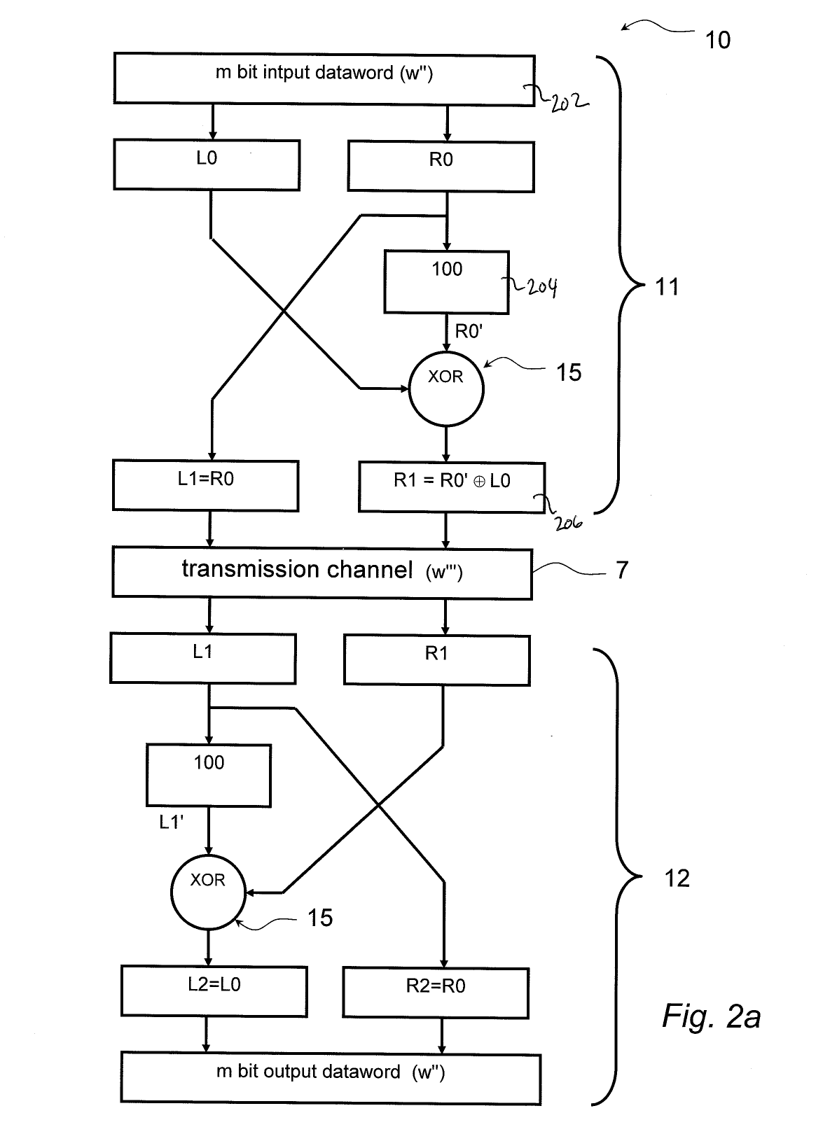

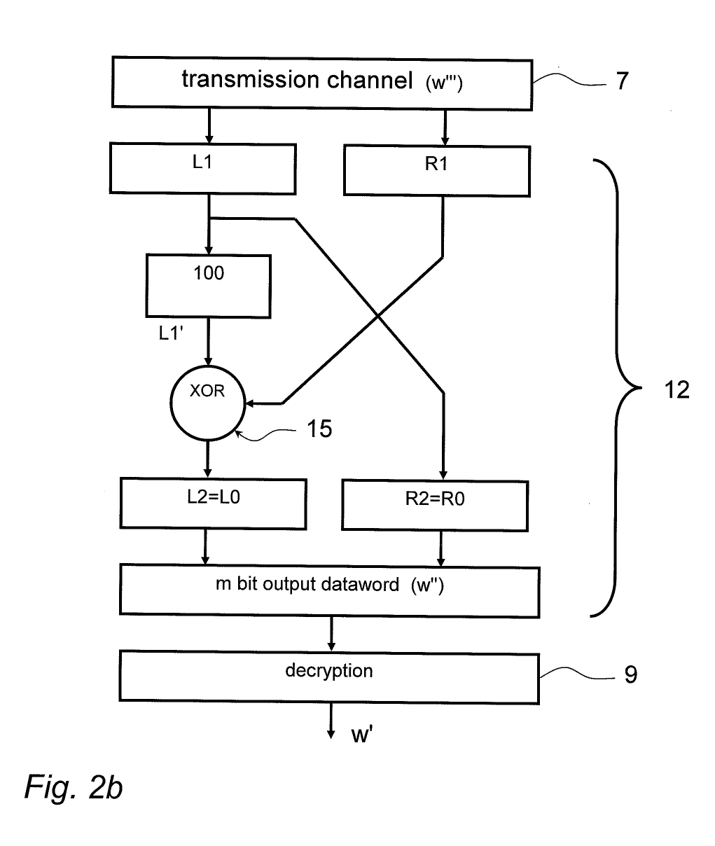

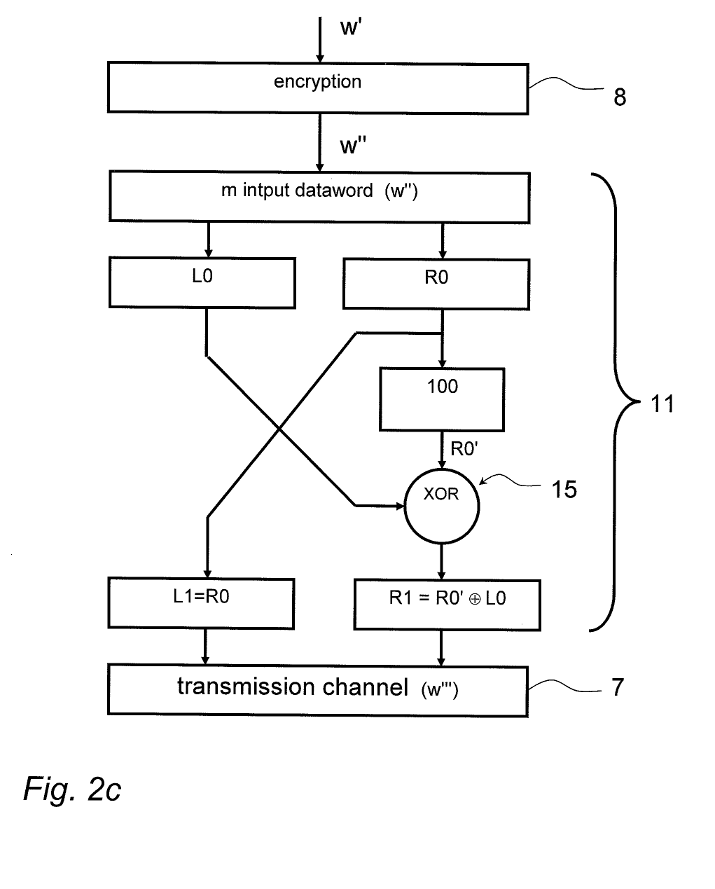

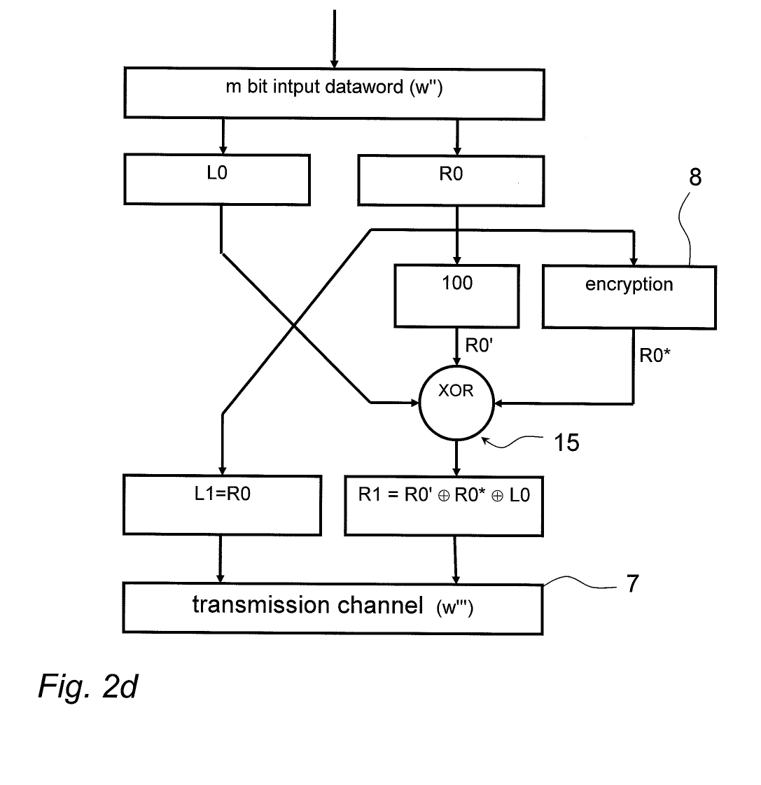

Referring to FIG. 2A, reversibility of the operations effected by the deceleration logic 101 can be achieved by embedding the deceleration logic in a Feistel structure 11, 12. An operation effected by a first Feistel structure 11 is always reversible here by a second Feistel structure 12 which is complementary to the first Feistel structure 11, even though the first Feistel structure 11 contains the nonreversible operation 100 effected by the logic 100.

The encoding of an m-bit-wide dataword w″ by means of Feistel structure 11 is effected here as follows:

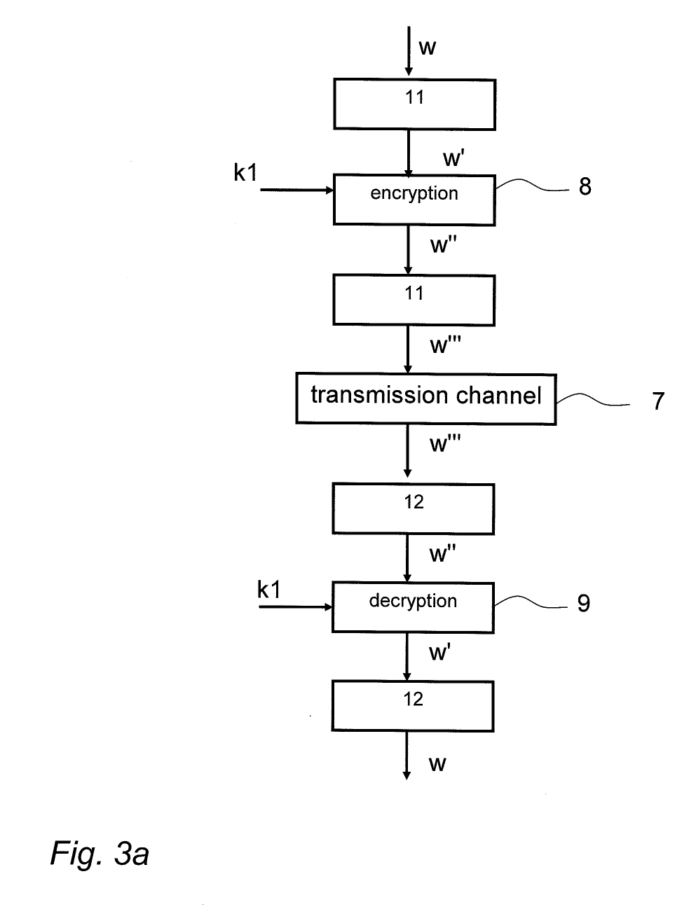

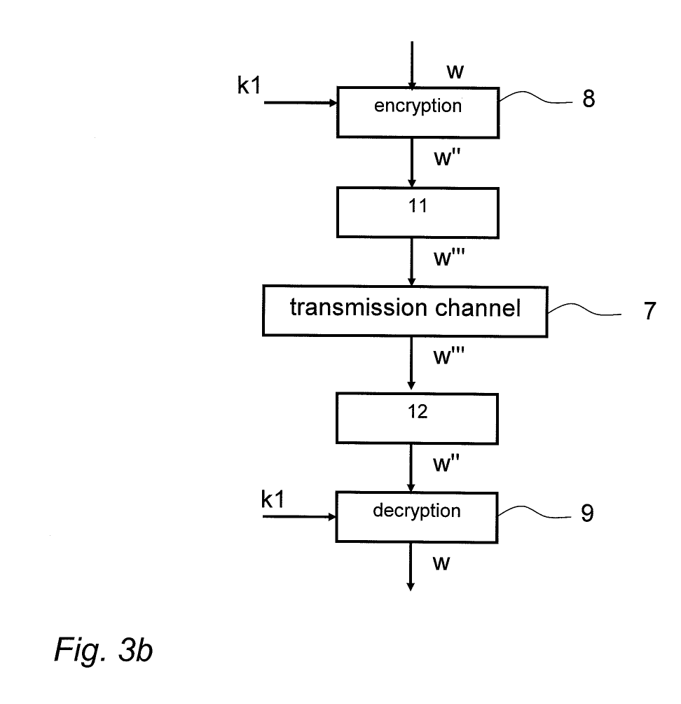

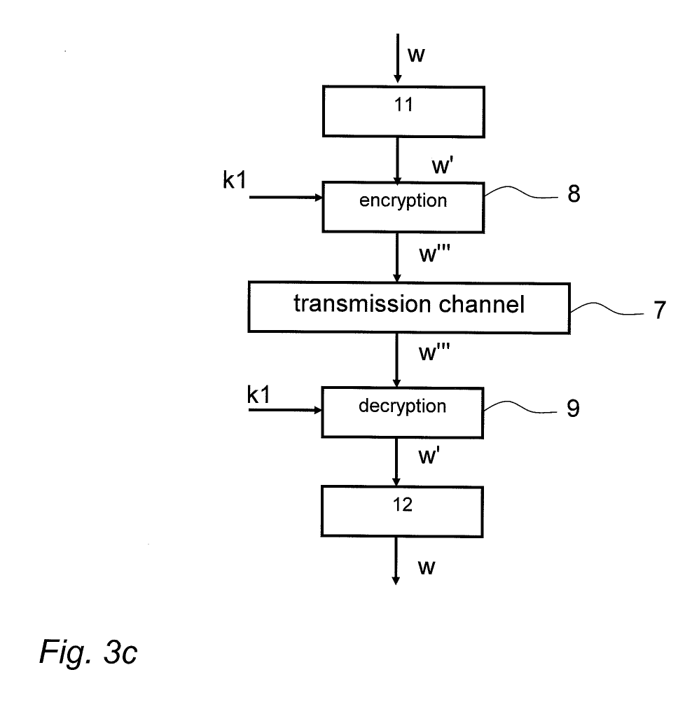

An m-bit-wide input dataword w″ is received from a source for example, as the result of an encryption algorithm 8 (see also FIG. 3A).

In step 202 the input dataword w″ is divided unto a first partial dataword L0 and a second partial dataword R0. In the example, both datawords have the same word width of n bits.

In step 204 the second partial dataword R0 is fed to the deceleration logic which effects single-bit operations 100 described based on FIGS. 1A and 1B. The result of the single-bit operations is an n-bit-wide modified second partial dataword R0′.

In a subsequent step, first partial dataword L0 is masked using modified dataword R0′. To this end, first partial dataword L0 is XORed bitwise with modified second partial dataword R0′. The result of this XOR operation is a masked partial dataword R1, where:

R1=R0′⊕L0 (1)

### The symbol ⊕ here represents a bitwise XOR operation.

At the output of Feistel structure 11, an output dataword comprising a first partial dataword L1 and a second partial dataword R1 is provided, where the first partial dataword L1 corresponds to the second partial dataword R0 provided at the input, while the second partial dataword R1 corresponds to the masked dataword R1 at the output.

The output dataword w″′ thus obtained may be transmitted through a transmission channel. Alternatively, it is possible to apply the encoding effected by the Feistel structure multiple times by feeding back the output dataword before a transmission at least once to the input of the Feistel structure in order to again run through the procedure as shown in FIG. 2A by the dashed arrow.

The encoding of input dataword w″ effected by the first Feistel structure 11 can be undone by the second Feistel structure 12 complementary to the first Feistel structure 11, where the second structure differs from the first structure 11 in that the single-bit operations 100 not reversible on their own are effected in the respective other branch. The single-bit operations 100 are thus applied to the partial dataword L1, with the result that one obtains a modified partial dataword L1′. This partial dataword L1′ is XORed with received partial dataword R1 and one obtains a partial dataword L2, where:

L2=L1′⊕R1 (2)

Partial dataword R2 is identical to received partial dataword L1. The two partial datawords L2 and R2 can be recombined to form a complete output dataword which is passed on, for example, to decryption logic 9. Also see FIG. 3A in this regard. Partial datawords L2 and R2 here correspond exactly to partial datawords R0 and L0. The receiver-side complementary Feistel structure 12 has equalized the effect of transmitter-side Feistel structure 11.

When the transmitter-side Feistel structure 11 is run through t times for each input dataword, the receiver-side complementary structure 12 has also been run through t times.

The reversibility of the technique applied by the transmitter-side Feistel structure 11 to input dataword w″ can be illustrated as follows:

The second partial dataword R0 is passed on unchanged to the other end of the data processing chain, such that:

R2=L1=R0 (3).

For first partial dataword L2, the following relationships apply that can be obtained directly by successive operation:

$$\begin{matrix}L 2 = R 1 ⊕ L {1}^{′} \\ = R 1 ⊕ R {0}^{′} \\ = L 0 ⊕ R {0}^{′} ⊕ R {0}^{′} \\ = L 0 ⊕ 0 \\ = L 0.\end{matrix} \qquad ( 4 )$$

What must be taken into account here is that an XOR of two identical expressions always produces zero (R0′⊕R0′=0), and the XOR of any expression with 0 does not change the expression (L0⊕0=L0).

Techniques of the present invention exploit the reversibility of single-bit operations obtained by embedding a Feistel structure. FIG. 2B illustrates an embodiment in which single-bit operations are effected by the deceleration logic 100 embedded in the Feistel structure 12 in a receiver unit before a decryption 9 of data transmitted in encrypted form. Dataword w″ received through a transmission channel 7 is first modified here by Feistel structure 12. Dataword w″ output by the Feistel structure 12 is fed to decryption logic 9 which supplies the decrypted dataword w′.

FIG. 2C illustrates processing complementary to the technique shown in FIG. 2B, which complementary can be employed on the transmitter side. An unencrypted dataword w′ is first encrypted to form an encrypted dataword w″. This encrypted dataword w″ is then fed to the Feistel structure 11 and modified by the single-bit operations 100 contained therein to form a dataword w″′. This modified dataword w″′ is then transmitted in the transmission channel 7.

A variant of the above-described embodiments is shown in FIG. 2D. The encryption 108 here does not take place before or after the Feistel structures 11 and 12 shown in FIGS. 2A through 2C, but instead within the structure in parallel with the single-bit operations 100. The result of the encryption RO* is then XORed with the partial dataword L0. An analogous procedure is possible for decryption.

As in the examples already described, an initially unencrypted dataword w″ is divided into a first partial dataword L0 and a second partial dataword R0. On the one hand, the single-bit operations shown in FIG. 1A or 1B are applied to the second partial dataword R0, and the operations supply the modified partial dataword R0′ as the result, while, on the other hand, encryption is applied that supplies the encrypted partial dataword R0* as the result. In a further step, modified partial dataword R0′ is XORed with the first partial dataword L0. The result of this XOR operation is partial dataword R1 (R1=R0′⊕R0*⊕L0). The partial dataword L1, which is identical to the partial dataword R0, and the partial dataword R1, together form the output dataword w″′ which is transmitted through the transmission channel 7 to a receiver. Alternatively, the structure described in FIG. 2D can also be run through multiple times in succession before the transmission.

FIG. 3A illustrates the decelerated data processing technique comprising transmitter-side encryption 8 and receiver-side decryption 9. In a first step, dataword w, which can be, for example, a component of a video stream, is modified on the transmitter side with the Feistel structure 11 shown in FIG. 2A. The result is a modified dataword w′. This is in turn fed to encryption logic which encrypts dataword w′ to form an encrypted dataword w″ using a k-bit-wide key k1. In order to achieve further deceleration, or to make necessary on the receiver side a multiple run-through of complementary Feistel structure 12, this encrypted dataword w″ may be modified once again by the Feistel structure 12 to form a dataword w″′. In principle, however, one Feistel structure 11 on the transmitter side and one complementary structure 12 on the receiver side may be sufficient.

After transmission of the dataword w″′ through the transmission channel 7, the transmitted dataword w″′ is modified by the complementary Feistel structure 12, and one again obtains the encrypted dataword w″. This is in turn decrypted by corresponding decryption logic 9 by using the key k1 to obtain the original modified dataword w′. In order to finally obtain the “original” dataword w, the modification effected on the transmitter side by the Feistel structure 11 must again be inverted by another complementary Feistel structure 12. The dataword w thus obtained can then be fed to a suitable reproduction device.

Referring to FIG. 3A, in a first step the input dataword w modifying by a single or multiple run-through the Feistel structure 11 (see FIG. 2A) with a block of single-bit operations 100 to obtain modified dataword w′. The modified dataword w′ is then encrypted using a key k1 to obtain encrypted dataword w″. Repeated modification of the encrypted dataword w″ by a single or multiple run-through of the Feistel structure 11 with a block of single-bit operations 100 may be performed to obtain dataword w″, which is transmitted through the transmission channel 7. The procedure is repeated on the receiver side using decryption logic 9 instead of encryption logic 8, and using the complementary Feistel structures 12 instead of the Feistel structures 11.

If keys are incorporated into the Feistel logic structures 11 on the transmitter side, as has been described with reference to FIG. 1B, then the same keys must be incorporated into the receiver-side structures which serve to effect deceleration. If on the transmitter side different keys k1, k2, are used in the circuits performed before and after the encryption, these keys are employed on the receiver side in the reverse sequence.

FIGS. 3B and 3C illustrate a simplified variant of the technique illustrated in FIG. 3A. Here only one Feistel structure 11 or 12 is present respectively on the transmitter side or receiver side. If the deceleration is effected on the transmitter side after encryption 8 with the Feistel structure 11, then deceleration must be provided on the receiver side by the Feistel structure 12 before decryption 9. This case is illustrated in FIG. 3B.

FIG. 3C illustrates the reverse case. Here the deceleration is effected on the transmitter side before encryption 8 by Feistel structure 11, while deceleration on the receiver side is effected after decryption 9 with Feistel structure 12.

Although the present invention has been illustrated and described with respect to several preferred embodiments thereof, various changes, omissions and additions to the form and detail thereof, may be made therein, without departing from the spirit and scope of the invention.

What is claimed is:

1. A data processing technique, comprising:
encryption or decryption of an input dataword (w′; w″) using a key (k1) in order to obtain an output dataword (w″; w′); and
application of reversible single-bit operations (11; 12) to the input dataword (w; w′; w″; w″′) before the encryption or decryption, and/or application of single-bit operations (11; 12) to the output dataword obtained by the encryption or decryption, wherein the single-bit operations are represented by a reduced Boolean operation.

2. The data processing technique of claim 1, where the application of the reversible single-bit operations (11; 12) is effected before and after encryption, or before and after the decryption.

3. A reversible processing method to decelerate a data processing chain, comprising:
receiving an input dataword;
dividing the input dataword into a first part (L0) and a second part (R0), where the first and second parts have the same word width;
applying single-bit operations to the partial dataword (R0) to obtain a modified partial dataword (R0)′, where the single-bit operations are represented by a minimized Boolean operation;
XORing the dataword (L0) with the modified partial dataword (R0′) in order to obtain a masked partial dataword; and
combining the partial dataword and the masked dataword (R1) to form an output dataword (w″′).

4. The data processing technique of claim 3, where the reversible method is performed multiple times in succession before and/or after the encryption and decryption.

5. The method of claim 3, comprising the following additional steps:
application of an encryption or decryption algorithm to the partial dataword to obtain an encrypted partial dataword; and
XORing the encrypted partial dataword with the dataword and the modified partial dataword (R0′) in order to obtain a masked partial dataword.

6. A data processing technique, comprising:
encryption or decryption of an input dataword using a key in order to obtain first output dataword (R0*);
application of reversible single-bit operations to the input dataword to obtain a second output dataword (R0′), wherein the single-bit operations are represented by a completely minimized Boolean operation; and
XORing the first output dataword (R0*) obtained by the encryption, and the second output dataword (R0′) obtained by the single-bit operations.
